(19) United States
(12) Patent Application Publication
(10) Pub. No.: US 2025/0111443 A1
(43) Pub. Date: Apr. 3, 2025

(54) Blockchain-based System for Facilitating, Validating, and Reconciling Intercompany Financial Transactions

(71) Applicant: Finthority, LLC, Sylvania, OH (US)

(72) Inventor: Joshua Maluchnik, Toledo, OH (US)

(73) Assignee: Finthority, LLC, Sylvania, OH (US)

(21) Appl. No.: 18/477,514

(22) Filed: Sep. 28, 2023

(51) Int. Cl. G06Q 40/12; G06Q 20/38; H04L 9/06

(52) U.S. Cl. CPC G06Q 40/12; G06Q 20/3827; G06Q 20/389; H04L 9/0643

(57) ABSTRACT

The present disclosure pertains to a blockchain-based system innovatively designed for streamlining, authenticating, and reconciling intercompany financial transactions. Central to this invention is a decentralized infrastructure coupled with specialized modules for transaction validation and ledger reconciliation. By harnessing advanced cryptographic hashing mechanisms, the system ensures transaction authenticity and leverages an integration module to interface with prevalent financial software systems, promoting automatic transaction data entry. An immutable ledger amplifies the system's security quotient, enhancing transparency and trust among stakeholders. With real-time ledger update capabilities, the invention obviates traditional discrepancies and inefficiencies inherent to intercompany financial processes, providing an integrated solution for superior financial transaction management in contemporary organizational settings.

### BACKGROUND OF THE INVENTION

The invention operates within the rapidly evolving sector of financial technology (FinTech), an interdisciplinary space that merges advanced technological solutions with modern financial services. While FinTech as a whole aims to improve and automate the delivery of financial services, this particular invention narrows its focus to the potent capabilities of blockchain technology. The primary objective is to harness the decentralized and transparent nature of blockchains to revolutionize the way financial transactions are conducted, validated, and reconciled-especially when these transactions span across varied departments within a corporation or between distinct legal business entities. In essence, the invention seeks to redefine intra and inter-organizational financial operations by mitigating traditional pain points and introducing a new standard of efficiency and security.

Intercompany transactions have been a longstanding pillar in the financial structures of multifaceted organizations. These transactions, whether they're conducted between different branches of a single company or entirely separate corporate entities, have historically been laden with complexities. Traditional systems necessitate the maintenance of multiple, often isolated, financial ledgers. The reconciliation process among these disparate ledgers frequently demands significant manual interventions, making it time-consuming and vulnerable to inaccuracies.

Centralized databases, which have been the cornerstone of these legacy systems, introduce a plethora of challenges. Their singular point of control lacks the holistic transparency that modern financial operations demand. This centralization not only presents a potential single point of failure but also becomes a lucrative target for cyber-attacks, thereby amplifying security concerns. Moreover, the predominantly manual nature of these systems can lead to unintentional human errors, or worse, create gateways for deliberate financial manipulations and frauds.

Given this backdrop, the financial realm has been actively seeking innovative solutions to overhaul these archaic systems. The overarching goal is to instate a mechanism that not only simplifies the intricate web of intercompany transactions but also embeds layers of security, transparency, and automation within it. The invention arises from recognizing this profound need and aspires to bridge the existing gaps by utilizing the transformative potential of blockchain technology.

### SUMMARY OF THE INVENTION

The present invention offers a groundbreaking advancement in the realm of intercompany financial management. Rooted in the principles and capabilities of blockchain technology, this novel system stands out as a beacon of robustness, security, and unmatched transparency. Unlike conventional mechanisms, which often stagnate due to their inherent inefficiencies and susceptibility to errors, this invention propels financial operations into a new era of accuracy and immediacy.

One of the primary feats of this invention is its capacity to offer real-time validation of transactions. As data enters the system, each transaction undergoes instantaneous verification, ensuring that the information is accurate and consistent across all parties involved. This immediate validation not only streamlines operations but also imparts a level of confidence previously unattainable with older systems.

In tandem with validation, the invention emphasizes real-time reconciliation, a feature that has transformative implications for intercompany financial management. Gone are the days of tedious cross-checking and lengthy reconciliation processes. The blockchain-based system autonomously reconciles entries, ensuring that all ledgers remain synchronized and accurate.

Furthermore, by decentralizing transactional data across a network of nodes, the invention drastically diminishes the vulnerabilities associated with centralized databases. This structure inherently safeguards against potential data breaches and unauthorized alterations. Consequently, the risk of fraudulent activities is substantially minimized, as altering any piece of data would require a consensus from a majority of the nodes-a feat nearly impossible to achieve without detection.

In essence, this invention marks a paradigm shift in intercompany financial management. It not only addresses the flaws of traditional systems but pioneers a forward-thinking approach, promoting efficiency, security, and transparency at every juncture.

### BRIEF DESCRIPTION OF DRAWINGS

To glean a deeper comprehension of the innovative facets, the inherent advantages, and the overarching objectives of the present invention, one should turn their attention to the subsequent detailed explanations that align seamlessly with the accompanying illustrations. In these diagrams, recurring reference numbers are typically indicative of analogous, functionally equivalent, and/or architecturally consistent components.

FIG. 1 is a system architecture diagram illustrating the foundational infrastructure and components of the blockchain-based financial management system.

FIG. 2 depicts a transaction flowchart detailing the step-by-step process involved in initiating, validating, and reconciling financial transactions within the system.

FIG. 3 represents an integration interface layout, highlighting the interaction points between the blockchain network and conventional financial software, emphasizing data sources, middleware, and API endpoints.

FIG. 4 portrays a focused view of the security features embedded within the system, emphasizing cryptographic methods, digital signatures, encryption protocols, and interactive security exchanges.

### DETAILED DESCRIPTION OF THE INVENTION

At the heart of this innovative solution is the strategic implementation of a decentralized blockchain network. This stands in stark contrast to the conventional, centralized databases that present multiple vulnerabilities. The decentralized essence of blockchain substantially diminishes potential points of failure, offering an augmented layer of security unparalleled by other financial technologies.

Within this network, individual transaction blocks are meticulously crafted to house multiple intercompany transactions. This structural design ensures that a vast amount of data is organized, secure, and easily retrievable.

Every transaction that is part of this system is subjected to a rigorous cryptographic hashing process. This isn't just a procedure; it's a vital security mechanism. By converting transaction data into a fixed string of numbers, it adds an intricate layer of defense against unauthorized alterations. Once hashed, the transaction's digital imprint is added to the blockchain. This process establishes a concrete link to the preceding transaction, resulting in a chronological, irreversible chain. The importance of this chained immutability cannot be overstated. It grants all stakeholders the confidence that once a transaction finds its place on the blockchain, its integrity remains intact, immune to tampering or unauthorized alterations.

In terms of adaptability, the system is architected to offer seamless integration capabilities with a plethora of existing financial software tools, whether they be comprehensive suites or specialized applications. Through the use of advanced APIs or other middleware technologies, this system facilitates the effortless transfer and population of transactional data into the blockchain ledger.

Once transactions are ensconced within the blockchain, they don't just sit idly. They are subjected to an instantaneous validation and reconciliation process, optimized for accuracy and speed. Harnessing the power of advanced algorithms, the system cross-references these transactions with various organizational ledgers, ensuring an unmatched level of consistency and transparency. This multidimensional verification ensures all participating entities have a clear, unified view of transactional data.

The automation of what was once a labor-intensive, error-prone process is perhaps the most transformative aspect of this invention. Through intelligent design and cutting-edge technology, the system drastically diminishes manual interventions, curtails the potential for human errors, and sets a new gold standard for efficiency and security in the realm of intercompany financial transactions.

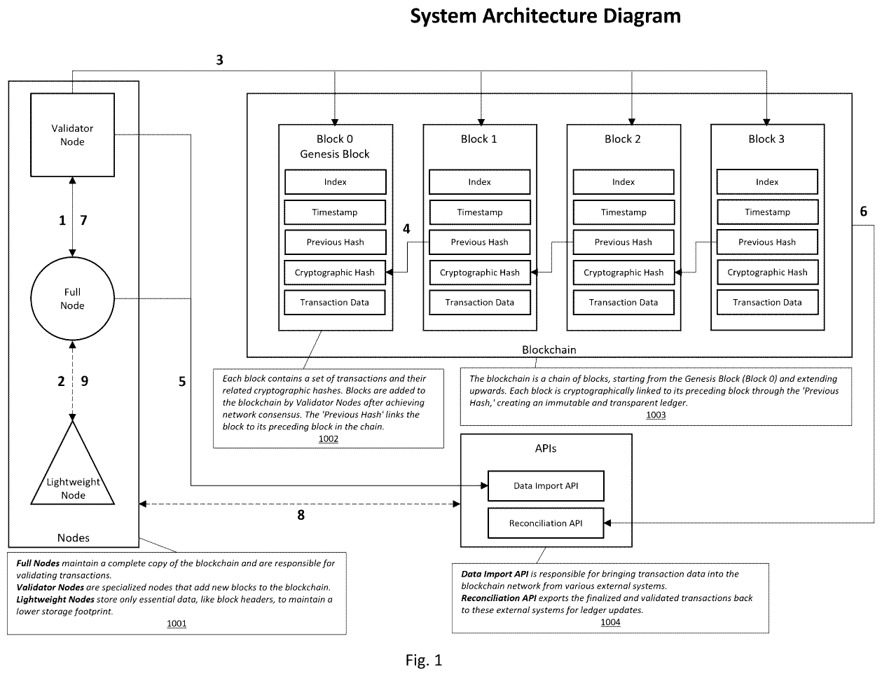

### Description of FIG. 1:

FIG. 1 elucidates the underlying architecture of the disclosed blockchain-based system. This architecture is conceptualized to span horizontally, delineating the systematic progression from nodes, through blocks, the encompassing blockchain, and concluding at the application programming interfaces (APIs).

Starting at the far left, the nodes section is diversified into Full Nodes, Validator Nodes, and Lightweight Nodes, each distinguishably represented by circles, squares, and triangles, respectively. A prominent solid two-way arrow, denoted as 7 in the diagram annotations, indicates a perpetual bidirectional communication between Full Nodes and Validator Nodes, essential for maintaining the network's robustness. In contrast, dotted two-way arrows, marked as 8 and 9, represent occasional data synchronization between Lightweight Nodes and Full Nodes. As further elucidated in box 1001, Full Nodes house exhaustive copies of the blockchain, validate transactions, Validator Nodes instigate the addition of new blocks, whereas Lightweight Nodes retain only the quintessential data.

Moving rightwards, each block, represented as a rectangle, encapsulates segments delineating Transaction Data and an accompanying Cryptographic Hash. Solid arrows, as marked by 3, trail from Validator Nodes to these blocks, emphasizing the nodes' pivotal role in appending these blocks. Box 1002 offers a deeper insight into the significance of both the Transaction Data and Cryptographic Hash housed within these blocks.

Continuing the rightward progression, the Blockchain section initiates with the foundational Genesis Block at its base, from which Subsequent Blocks ascend horizontally. Each of these blocks is intrinsically connected to its predecessor via horizontal lines, marked as 4, symbolizing the cryptographic linkages that anchor this immutable chain together. Box 1003 provides a comprehensive elucidation of how each block's cryptographic hash reinforces this chain's unalterable nature.

Concluding the architecture, two distinctive API icons emerge: Data Import API and Reconciliation API. Solid arrows, annotated as 5 and 6, originate from Full Nodes and Validator Nodes, gravitating towards the Data Import API, and from the Blockchain towards the Reconciliation API, respectively. These arrows accentuate the pivotal real-time data import and export processes. Box 1004 delineates the diverse roles each API performs in the intricate ballet of data orchestration between the blockchain and external financial systems.

Accompanying the visual representation, FIG. 1 is enhanced with annotations delineating the sequence and nature of actions. These annotations, numbered 1 through 9, act as keys, furnishing detailed descriptions for each interaction type, be it the constant communication between Full Nodes and Validator Nodes, or the intermittent synchronization between Lightweight Nodes and Full Nodes. These annotations serve as a guide, ensuring a holistic understanding of the system's intricate mechanisms.

This comprehensive architecture diagram, embodying the nodes, blocks, blockchain, and APIs, lays the foundational blueprint for the system, offering stakeholders a lucid visual representation of the system's intricate workings.

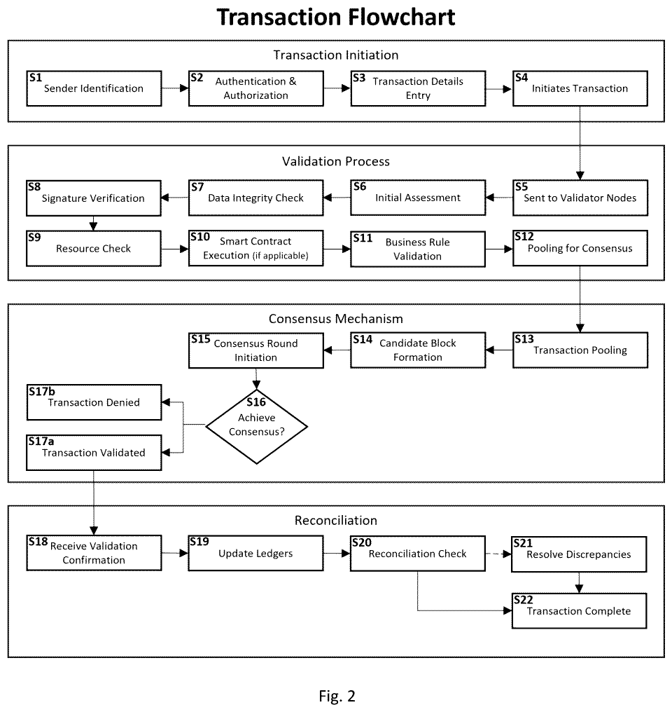

### Description of FIG. 2:

FIG. 2 outlines a detailed and comprehensive transaction flow, guiding a transaction from initiation through to completion, ensuring its accuracy, authenticity, and compliance with all necessary criteria.

The transaction initiation process begins with Sender Identification S1. This step represents the entity initiating the transaction, whether it be a user, financial institution like a bank, or even an automated system. This identification does not involve any particular flow direction as indicated by the lack of an arrow.

Following identification, there's a solid, single-directional arrow leading to the next step, Authentication & Authorization S2. This crucial step ensures the sender's identity and its authority to initiate a transaction. It may encompass mechanisms such as entering login credentials or even a more secure multi-factor authentication method.

After successful authentication, the sender proceeds to enter the required Transaction Details S3. Information such as the recipient's address and the specific amount to be transferred are input here.

Upon entering the necessary details, the sender then confirms and decides to Initiate the Transaction S4, which can be done manually or via an automated API. This initiation sends the transaction details into the system, ready to be validated.

Once the transaction is initiated, it moves to the validation process where the information is Sent to Validator Nodes S5, as indicated by a single-directional arrow from the initiation step. Validator nodes are responsible for checking the integrity, authenticity, and validity of transactions.

Validators first conduct an Initial Assessment S6 on the transaction to check for proper format and completeness. If the transaction details conform to the required standards, the process moves on to the Data Integrity Check S7, where cryptographic hashing ensures the accuracy and wholeness of the transaction data.

Upon ensuring data integrity, the process then validates the Signature Verification S8. This step authenticates the digital signature associated with the sender, confirming its legitimacy.

Subsequently, a Resource Check S9 is conducted to ascertain that the sender possesses enough resources or funds to carry out the transaction.

If the transaction involves the execution of terms and conditions, the Smart Contract Execution S10 step comes into play. At this juncture, any necessary conditions are met to proceed.

Following either the Resource Check or Smart Contract Execution, the transaction is subject to Business Rule Validation S11. This involves additional checks pertaining to compliance or specific enterprise criteria.

If the transaction successfully navigates the aforementioned validations, it is then Pooled for Consensus S12, joining other transactions that await the consensus process.

Transactions, once validated, move into the consensus mechanism to Transaction Pooling S13 where they congregate with other validated transactions. These pooled transactions are then compiled into a Candidate Block Formation S14, proposing a new block for the blockchain.

With the formation of a candidate block, a Consensus Round Initiation S15 starts, setting the stage for validating the proposed block with all its transactions. This leads to a decision point, represented by the diamond-shaped Achieve Consensus? S16. Here, the system determines whether the transactions achieve a consensus.

If consensus is reached, the transaction is deemed Validated S17a. This approval signifies that the transaction has met all network and protocol criteria for inclusion in the blockchain.

Post consensus, the system engages in the reconciliation process by receiving validation confirmation S18, ensuring that the transaction was validated. Following confirmation, Update Ledgers S19 takes place where both the blockchain and any external ledgers record the transaction.

A subsequent Reconciliation Check S20 ensures alignment between the blockchain and external ledgers. If discrepancies arise, they are addressed in the Resolve Discrepancies S21 step. This is an optional step, denoted by a dotted arrow, and is invoked only if differences between ledgers are detected.

The final step marks the Transaction Complete S22. This culmination denotes a successful transaction lifecycle, with all validations, decisions, and reconciliations executed. The ledgers-both within the blockchain and outside-have been updated and verified, potentially triggering other subsequent processes such as reporting or notifications.

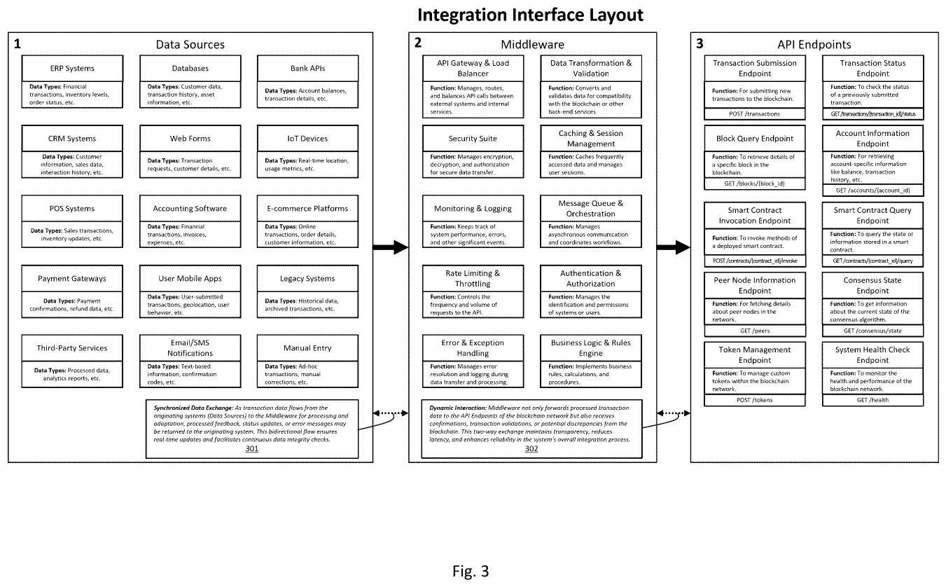

### Description of FIG. 3:

FIG. 3 meticulously breaks down the interactions, processes, and exchanges between traditional data sources and a blockchain network. It underscores the pivotal role of middleware in facilitating these integrations and the bidirectional data flows that ensure the system remains updated, integrated, and coherent.

The visual layout of this diagram is horizontally oriented. On the far left side, the existing financial systems, including ERP systems, databases, and more, are showcased. On the opposite end, the right side, the blockchain network is presented. The central space between these two realms illustrates the interaction points and middleware that serve as a bridge.

Delving into the Data Sources 1 on the left-most part of FIG. 3, we see a representation of the various origins from which data is sourced. Notable components include ERP Systems, like SAP ERP and Oracle ERP Cloud, which primarily focus on financial transactions and inventory levels. Databases, with examples such as SQL and NoSQL, typically contain customer data and transaction histories. Other sources, such as Bank APIs through platforms like Plaid and Yodlee, offer insights into account balances and transaction details. The list extends to incorporate CRM systems, web forms, and several other data sources, each serving unique functionalities and data types.

Centered in the diagram, the Middleware 2 box elucidates the mechanisms and components used to process and transfer this data. Essential components within this middleware framework include the API Gateway & Load Balancer, responsible for managing and balancing API calls. There's also the Data Transformation & Validation component that focuses on ensuring data compatibility. Additionally, the Security Suite emphasizes the importance of data encryption, decryption, and authorization. This middleware segment also boasts components that cater to caching, monitoring, message queuing, and more, ensuring data's efficient, secure, and streamlined transition.

On the far right, the API Endpoints 3 box provides a clear delineation of the different blockchain interaction points. These endpoints range from transaction submissions, denoted with “POST/transactions”, to block queries, represented by “GET/blocks/{block_id}”, and several others in between. Each of these endpoints has distinct functions, ensuring diverse interactions with the blockchain network.

The data flow is elegantly showcased via solid arrows, tracing from Data Sources 1 to Middleware 2, signifying the one-directional journey of transaction data. From the middleware to the blockchain network's API Endpoints 3, similar arrows depict the data's progression. However, two-way dotted arrows, present between certain components, emphasize data looping back to its origin.

Two critical annotations further enrich the diagram's narrative. Firstly, the Synchronized Data Exchange 301 between Data Sources 1 and Middleware 2 highlights the bidirectional data exchange, spotlighting real-time updates and continuous data integrity checks. Secondly, the Dynamic Interaction 302 between Middleware 2 and API Endpoints 3 underscores the significance of two-way data exchanges in maintaining system transparency, reducing latency, and boosting overall reliability.

In essence, FIG. 3 offers a comprehensive view of how diverse data sources integrate seamlessly with a blockchain network, emphasizing the importance of middleware and dynamic interactions.

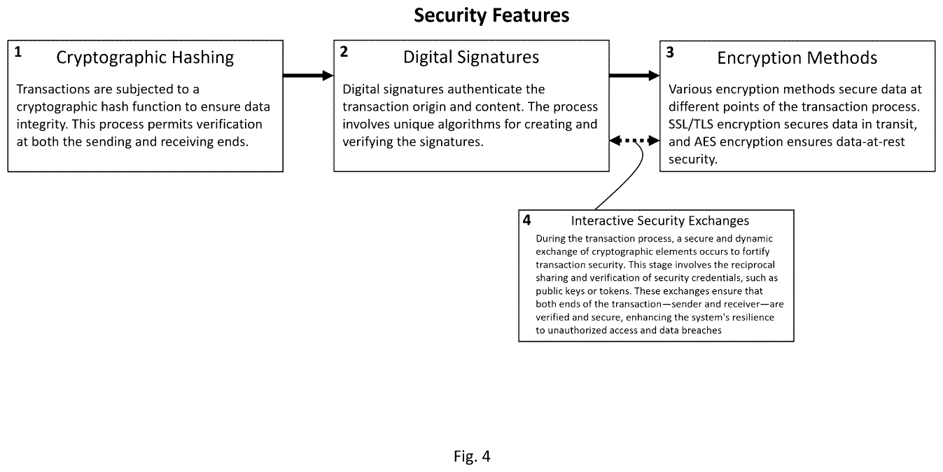

### Description of FIG. 4:

FIG. 4 shines a spotlight on the comprehensive security apparatus underpinning the blockchain network, safeguarding both transactions and data. The illustration methodically captures the transaction's journey, unfolding linearly to exhibit its evolution from initiation through to validation and its eventual reconciliation. Each pivotal juncture within this progression is meticulously layered with specific security measures, ensuring that the transaction data is continually fortified.

At the very onset of a transaction's life cycle, it encounters the robust security mechanism of cryptographic hashing 1. This key component utilizes formidable algorithms like SHA-256, transforming transactional data into a fixed-size character string. Such a transformation ensures that each transaction is endowed with a unique, immutable fingerprint, markedly enhancing its resistance against any unauthorized alterations or tampering.

As the transaction progresses, readying itself for onward transmission or validation, it is armored with digital signatures 2. These are not mere markers but are cryptographic seals, intricately forged using advanced encryption algorithms. Their primary function is to vouch for the authenticity and originality of the transaction, ensuring that its sanctity remains untainted post-creation. This imprints an added layer of trust, reinforcing the system's credibility.

While navigating through the network, or even when interacting with external domains, the transaction is enveloped within a robust shield of encryption methods 3. This multifaceted encryption paradigm employs the SSL/TLS protocols to guard data in motion, ensuring its safe passage. Conversely, when data is dormant or at rest, it is encased within the protective confines of encryption techniques like AES. This all-encompassing encryption strategy stands as a testament to the system's commitment to preserving data confidentiality, shielding it from unauthorized access or breaches.

Central to the transactional flow is the dynamic and interactive security exchange 4. This phase is emblematic of the system's sophisticated security dance, involving a bidirectional and harmonious exchange of key cryptographic credentials such as public keys or tokens. By facilitating this mutual validation of both the sender and the recipient, the system exponentially heightens its resilience, ensuring fortified defenses against potential unauthorized activities and potential data breaches.

In essence, the Security Features diagram of FIG. 4 meticulously delineates the blockchain network's unwavering dedication to ensuring transactional integrity. Through its strategic employment of cryptographic hashing 1, digital signatures 2, encryption methods 3, and interactive security exchanges 4, it offers unparalleled security advantages over traditional transactional paradigms.

1. A blockchain-based system designed explicitly for streamlining, authenticating, and reconciling intercompany financial transactions, the system encompassing:
a decentralized infrastructure comprising multiple nodes;
a transaction validation module tailored to inspect transaction authenticity;
a reconciliation engine built to harmonize transactional data across varied ledgers.

2. The system of claim 1, wherein the transaction validation module employs advanced cryptographic hashing mechanisms, ensuring the uniqueness and authenticity of every individual transaction processed.

3. The system of claim 1, characterized in that the reconciliation engine is equipped with real-time ledger update capabilities, thereby ensuring synchronized and updated financial records across different organizational divisions without delay.

4. The system of claim 1, further incorporating:
an integration module endowed with compatibility features, allowing it to seamlessly interface with a broad spectrum of established financial software systems; and
mechanisms facilitating automatic population of transactional data into the blockchain ledger.

5. The system of claim 1, wherein the system's ledger, due to its immutable nature, amplifies the security quotient and augments the transparency level, ensuring all stakeholders have an unequivocal and trusted view of intercompany transactions.

6. The system of claim 1, wherein the nodes in the decentralized network play a pivotal role in transaction validation, each node independently verifying the transaction, thus bolstering transactional integrity.

7. The system of claim 1, characterized in that the integration module supports both API-based and middleware-driven connectivity, optimizing the system's adaptability quotient to varying financial software landscapes.

8. The system of claim 2, wherein the cryptographic hashing utilized is of the SHA-256 variety or its equivalent, ensuring state-of-the-art security for each transaction.

9. The system of claim 1, wherein the reconciliation engine employs advanced algorithms and cross-referencing techniques, minimizing discrepancies and ensuring ledger uniformity across all organizational platforms.

10. The system of claim 1, wherein automated alerts or notifications are generated in cases of transactional anomalies or discrepancies, enabling swift remedial actions.
